(19) United States
(12) Patent Application Publication
(10) Pub. No.: US 2002/0107044 A1
(43) Pub. Date: Aug. 8, 2002

(54) Integrated information display and piezoelectric sound generator and applied devices thereof

(75) Inventors: Jun Kuwata, Tokyo (JP); Atsushi Omote, Sagamihara-shi (JP)

Correspondence Address: CONNOLLY BOVE LODGE & HUTZ LLP, SUITE 800, 1990 M STREET NW, WASHINGTON, DC, 20036-3425, US

(73) Assignee: MATSUSHITA ELECTRIC INDUSTRIAL CO., LTD, Osaka (JP)

(21) Appl. No.: 10/067,360

(22) Filed: Feb. 7, 2002

(30) Foreign Application Priority Data
Feb. 7, 2001 (JP) 2001-30568

(51) Int. Cl. H04M 1/00

(52) U.S. Cl. 455/550; 455/90; 379/433.01

(57) ABSTRACT

A piezoelectric oscillator is provided on a bottom surface of a resonance box of a piezoelectric sound generating device. A thin flat display is integrally formed on a top surface of the resonance box as part of the resonator.

### BACKGROUND OF THE INVENTION

The present invention relates to an integrated information display and piezoelectric sound generating device applicable to portable telephones, computers, small electronic devices, digital video cameras, mobile information terminals, or the like.

Recent advanced portable telephones have the capability of transmitting and receiving video and text (i.e., characters, symbols and the like) information in addition to sound information. In future, the real-time transmission/reception of video and sound information will be widely used in this kind of mobile or communication devices. In this respect, downsizing, reduction of thickness, and weight reduction are technical goals to be attained for the future mobile and/or communication devices.

### SUMMARY OF THE INVENTION

In view of the foregoing problems, the present invention has an object to provide an information communication device utilizing a piezoelectric member which is one of prospective materials in realizing the downsizing and weight reduction of this kind of communication devices. Various communication devices, such as portable telephones, computers and the like, have speakers, receivers and microphones which can be made of piezoelectric members.

More specifically, the present invention provides an information communication device incorporating a compact and highly sensitive piezoelectric oscillator.

In general, the communication devices include an information display screen and a sound generating source. Due to increase of transmitted and received information or data, an available space for the display screen must be large for the future mobile or communication devices. In this respect, it is desirable that the information display section has a wide display screen but is thin in thickness and light in weight. It is also desirable that the sound generating source is compact in size, thin in thickness, and light in weight.

The present invention provides a piezoelectric sound generating device utilizing excellent performance of a thin-plate piezoelectric element and also realizes an advanced display device having a wide information display screen.

The present invention provides an integrated information display and sound source which is capable of generating a large sound volume in the vicinity of the display screen.

To accomplish the above and other related objects, the present invention provides an integrated information display and piezoelectric sound generating device comprising a thin-plate piezoelectric element serving as an oscillating source of a sound signal and a display device serving as part of a resonator.

With this arrangement, it becomes possible to integrate the display unit with the resonator so as to generate a large sound volume in the vicinity of (or adjacent to) a display screen.

More specifically, the thin-plate piezoelectric element is attached to a resonance box of the resonator. The display device is located on a top surface of the resonator. For example, thin-plate piezoelectric element can be constituted by a plurality of piezoelectric oscillators. The thin-plate piezoelectric element can be located in a lateral direction of the resonator so as to cause acoustic oscillation by repeating expansion and contraction in the lateral direction. The thin-plate piezoelectric element is connected to the thin flat display via an oscillation transfer pole. Meanwhile, the display device can be selected from the group consisting of a liquid crystal display, an organic electro-luminescent display, a reflection liquid crystal display, and a thin-film display formed on a resin substrate.

Furthermore, to provide a practical arrangement for the mobile and/or communication devices, the present invention provides an integrated information display and piezoelectric sound generating device comprising a resonance box, a piezoelectric oscillator attached to a surface of the resonance box, and a thin flat display integrally formed with the resonance box.

According to preferred embodiments of the present invention, it is preferable that the thin flat display is integrally provided on a top surface of the resonance box.

It is also preferable that the piezoelectric oscillator is provided on an inner bottom surface or an outer bottom surface of the resonance box or on both of them.

It is also preferable that a plurality of sound openings are provided in the vicinity of or adjacent to the thin flat display on the top surface of the resonance box.

It is also preferable that the piezoelectric oscillator is connected to the thin flat display via an oscillation transfer pole.

It is also preferable that the piezoelectric oscillator has a thin-plate body extending parallel to the thin flat display.

It is also preferable that the thin flat display is a liquid crystal display, or an organic electro-luminescent display, or a reflection liquid crystal display. The thin flat display can be formed as a thin-film display formed on a resin substrate.

It is also preferable that the resonance box is made of a plurality of materials having different oscillatory characteristics. For example, the resonance box is made of a first material except for the bottom on which the piezoelectric oscillator is provided, and the bottom of the resonance box is made of a second material. An elastic coefficient of the second material is larger than that of the first material. The second material is a polymeric material. An elastic coefficient of the first material is substantially identical with that of the thin flat display.

It is preferable that the piezoelectric oscillator is connected to sound signal leads and the thin flat display is connected to display signal leads. To this end, the resonance box has a hole, and the sound signal leads and the information display signal leads extend out of the resonance box via this hole. The hole is provided on the bottom of the resonator box.

It is preferable that the resonance box has electric terminals to which signal leads of the piezoelectric oscillator are connected by soldering or by means of connectors.

Furthermore, the present invention provides a mobile information terminal comprising a resonance box incorporated in a body of the mobile information terminal, a piezoelectric oscillator provided on a bottom surface of the resonance box, and a thin flat display formed on a top surface of the resonance box so that the thin flat display is located on a front face of the mobile information terminal.

In this case, it is preferable that a plurality of sound openings are provided in the vicinity of or adjacent to the thin flat display on the front face of the mobile information terminal. A core camera and a microphone are provided on the front face of the mobile information terminal.

Furthermore, the present invention provides a wristwatch type mobile information terminal comprising a resonance box, a piezoelectric oscillator provided on a bottom surface of the resonance box, and a thin flat display formed on a top surface of the resonance box.

Furthermore, the present invention provides a digital versatile disk player comprising a resonance box, a piezoelectric oscillator provided on a bottom surface of the resonance box, and a thin flat display formed on a top surface of the resonance box.

Furthermore, the present invention provides a portable telephone comprising a resonance box incorporated in a body of the portable telephone, a piezoelectric oscillator provided on a bottom surface of the resonance box, a thin flat display formed on a top surface of the resonance box so that the thin flat display is located on a front face of the portable telephone, and a plurality of sound openings provided in a peripheral region of the thin flat display located on the front face of the portable telephone.

Furthermore, the present invention provides a video camera comprising a resonance box incorporated in a body of the video camera, a piezoelectric oscillator provided on a bottom surface of the resonance box, a thin flat display formed on a top surface of the resonance box so that the thin flat display is located on a front face of the video camera, and a plurality of sound openings provided in a peripheral region of the thin flat display located on the front face of the video camera. For example, the resonance box is provided in a swingable lid of the video camera.

Furthermore, the present invention provides an apparatus for recording and reproducing video and acoustic (or audio) information, comprising a resonance box incorporated in a body of the recording and reproducing apparatus, a piezoelectric oscillator provided on a bottom surface of the resonance box, a thin flat display formed on a top surface of the resonance box so that the thin flat display is located on a front face of the recording and reproducing apparatus, and a plurality of sound openings provided in a peripheral region of the thin flat display located on the front face of the recording and reproducing apparatus.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a perspective view showing a schematic arrangement of an integrated information display and piezoelectric sound generating device in accordance with a first embodiment of the present invention;

FIG. 2 is a cross-sectional view showing an arrangement of the integrated information display and piezoelectric sound generating device shown in FIG. 1;

FIG. 3 is a cross-sectional view showing an arrangement of an integrated information display and piezoelectric sound generating device in accordance with a second embodiment of the present invention;

FIG. 4 is a cross-sectional view showing an arrangement of an integrated information display and piezoelectric sound generating device in accordance with a third embodiment of the present invention;

FIG. 5 is a cross-sectional view showing an arrangement of an integrated information display and piezoelectric sound generating device in accordance with a fourth embodiment of the present invention;

FIG. 6 is a cross-sectional view showing an arrangement of an integrated information display and piezoelectric sound generating device in accordance with a fifth embodiment of the present invention;

FIG. 7 is a front view showing a mobile information terminal in accordance with a sixth embodiment of the present invention, incorporating the integrated information display and piezoelectric sound generating device in accordance with the preferred embodiment of the present invention;

FIG. 8 is a perspective view showing a wire arrangement of the integrated information display and piezoelectric sound generating device in accordance with a seventh embodiment of the present invention;

FIG. 9 is a cross-sectional view showing a practical wire arrangement of the integrated information display and piezoelectric sound generating device shown in FIG. 8;

FIG. 10 is a cross-sectional view showing another practical wire arrangement of the integrated information display and piezoelectric sound generating device shown in FIG. 8 in accordance with an eighth embodiment of the present invention;

FIG. 11A is a front view showing a conventional portable telephone;

FIG. 11B is a front view showing a portable telephone in accordance with a ninth embodiment of the present invention, incorporating the integrated information display and piezoelectric sound generating device in accordance with the preferred embodiment of the present invention;

FIG. 12 is a perspective view showing a video camera in accordance with a tenth embodiment of the present invention, incorporating the integrated information display and piezoelectric sound generating device in accordance with the preferred embodiment of the present invention; and

FIG. 13A through 13D are views explaining sound generating mechanism of the integrated information display and piezoelectric sound generating device in accordance with the present invention.

### DESCRIPTION OF PREFERRED EMBODIMENTS

Hereinafter, preferred embodiments of the present invention will be explained with reference to the attached drawings.

### First Embodiment

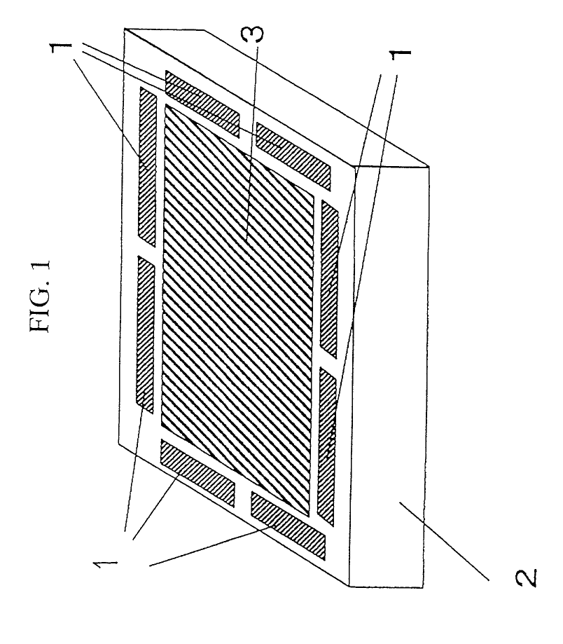

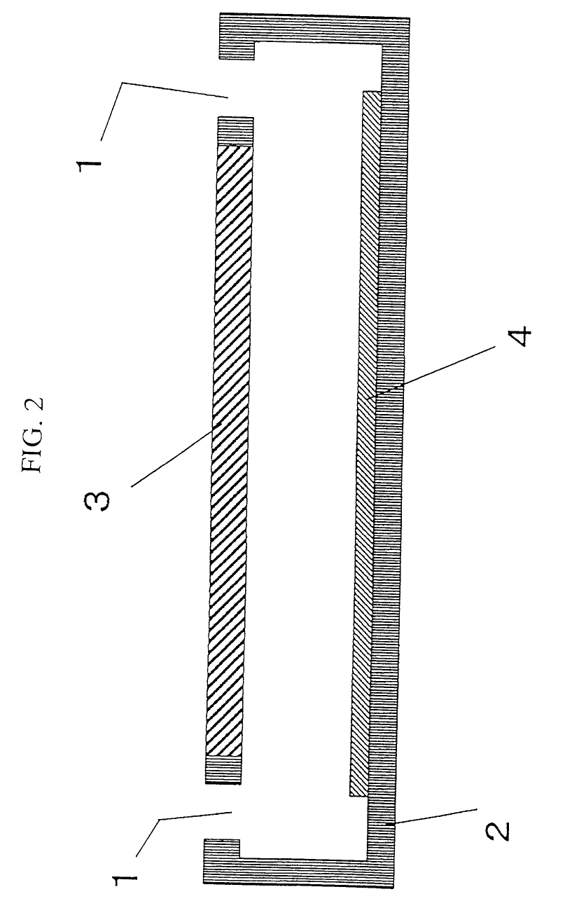

FIG. 1 shows an appearance of an integrated information display and piezoelectric sound generating device in accordance with a preferred embodiment of the present invention. FIG. 2 is a cross-sectional view showing the integrated information display and piezoelectric sound generating device shown in FIG. 1.

The integrated information display and piezoelectric sound generating device has a boxlike body serving as a resonance box 2. The resonance box 2 has a lateral size longer than a vertical size (i.e., a height).

A thin flat display 3, such as a thin liquid crystal display, an organic electro-luminescent display, a reflection liquid crystal display, or the like, is integrally provided on a top surface of the resonance box 2. In this respect, the thin flat display 3 constitutes part of the resonance box 2. As one of practical examples, the thin flat display 3 may be a thin-film display formed on a resin substrate.

A plurality of sound openings 1 are provided in the vicinity of or adjacent to the peripheral region (i.e., along each side of four edges) of the rectangular thin flat display 3 on the top surface of the resonance box 2. A thin platelike piezoelectric oscillator 4, placed on an inner bottom surface of the resonance box 2, generates acoustic oscillation or vibration. The bottom of resonance box 2 serves as diaphragm (i.e., an oscillating plate). The resonance box 2 is made of a metallic plate or a comparable member (such as plastic).

The resonance box 2 enhances the acoustic oscillation caused by the piezoelectric oscillator 4. Each sound opening 1 outputs the resonated sound (i.e., enhanced sound) to the outside of the integrated information display and piezoelectric sound generating device. In this respect, the integrated information display and piezoelectric sound generating device of this embodiment is a resonator.

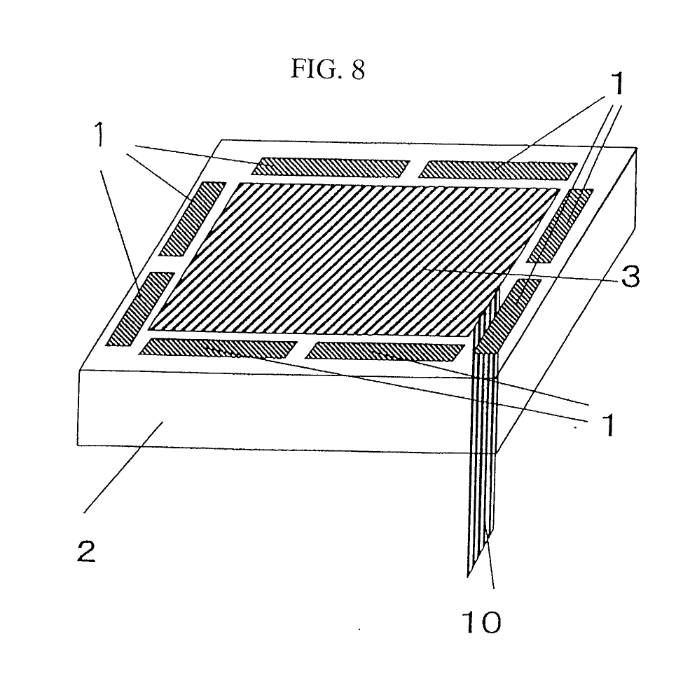

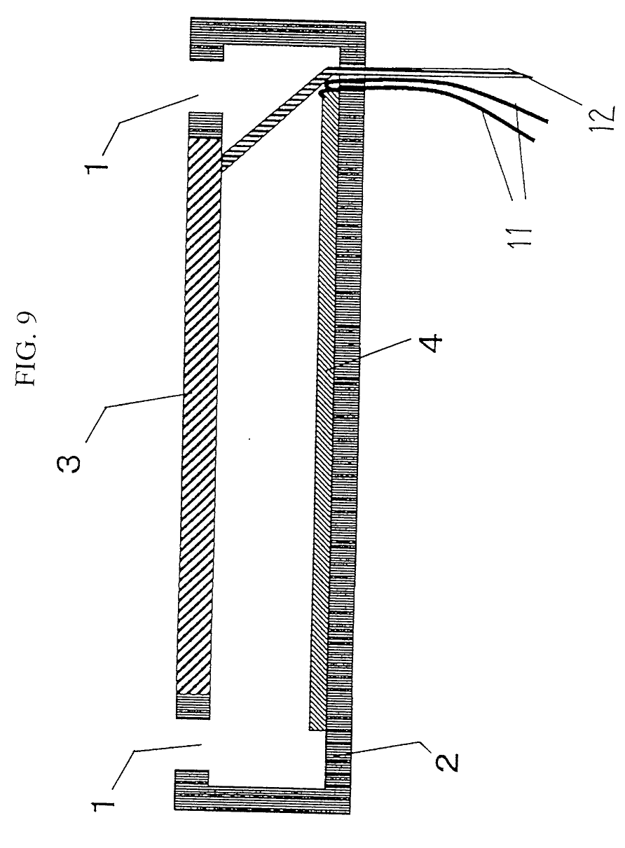

Although not shown in FIGS. 1 and 2, the piezoelectric oscillator 4 receives an alternating voltage via electric leads (i.e., leads 11 shown in FIG. 9) in accordance with an acoustic (or audio) signal. The thin flat display 3 receives electric signals via leads (i.e., leads 10 shown in FIG. 8 or leads 12 shown in FIG. 9). The piezoelectric oscillator 4 causes oscillation in response to the alternating voltage corresponding to the acoustic (or audio) signal.

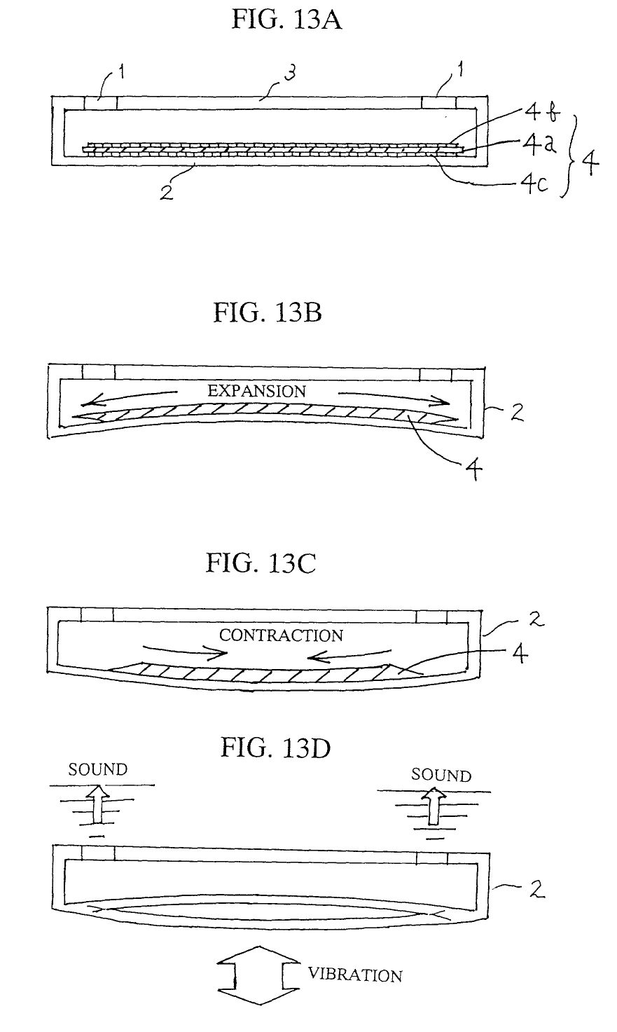

FIGS. 13A through 13D explain the sound generating mechanism of this embodiment.

As shown in FIG. 13A, a thin platelike piezoelectric member 4a is held or sandwiched between flat parallel electrodes 4b and 4c as integrated unit which is directly fixed on the bottom of resonance box 2.

In the explanation of this embodiment, the integrated unit of platelike piezoelectric member 4a and two parallel electrodes 4b and 4c is referred to as thin platelike piezoelectric oscillator 4.

When an alternating voltage corresponding to a given acoustic (or audio) signal is applied to the electrodes 4b and 4c , the piezoelectric member 4a repeats expansion and contraction in the longitudinal direction thereof (i.e., in the lateral direction of the resonance box 2). FIG. 13B shows the expansion of thin platelike piezoelectric oscillator 4 wherein the thin platelike piezoelectric oscillator 4 expands in a longitudinal direction thereof. FIG. 13C shows the contraction of thin platelike piezoelectric oscillator 4 wherein the thin platelike piezoelectric oscillator 4 contracts in the opposite direction. Thus, in response to the received alternating voltage signal, the thin platelike piezoelectric oscillator 4 causes vibration (i.e., the acoustic oscillation) at the bottom of resonance box 2 (i.e., at the diaphragm) as shown in FIG. 13D. The resonance box 2 enhances the generated acoustic oscillation. The resonated sound (i.e., enhanced sound) is emitted through the sound openings 1 to the outside of the resonance box 2.

In this manner, the resonance box 2 causes resonance in accordance with the oscillation of the piezoelectric oscillator 4 and, as a result, amplifies the acoustic oscillation at a predetermined frequency band. The acoustic oscillation thus produced is propagated by means of air via the sound openings 1 to the outside of the resonance box 2.

The thin flat display 3 also oscillates together with the resonance box 2 and therefore performs the function of increasing or enhancing the sound pressure. According to the arrangement of this embodiment, it becomes possible to effectively arrange the thin flat display 3 and the sound openings 1 in a limited space. This embodiment not only realizes downsizing of the display/sound device but also attains a desired level of sound pressure. For example, the sound pressure attained by this embodiment is higher than a conventional sound pressure by an amount of 10 dB or more whereas the conventional sound pressure is in a level of 80 dBSPL (0.3W).

### Second Embodiment

A second embodiment of the present invention is similar to the above-described first embodiment of the present invention except for a change indicated below.

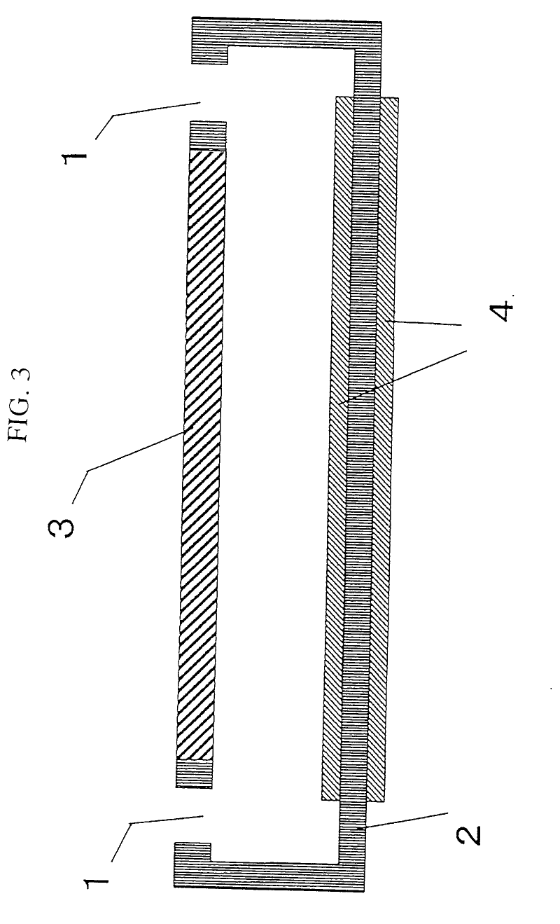

FIG. 3 shows an arrangement of the integrated information display and piezoelectric sound generating device in accordance with the second embodiment of the present invention.

The integrated information display and piezoelectric sound generating device shown in FIG. 3 is different from the device shown in FIG. 2 in that a pair of piezoelectric oscillators 4 are provided on inner and outer bottom surfaces of the resonance box 2. This arrangement greatly increases the acoustic pressure. In other words, an actuation voltage for the piezoelectric member 4a (i.e., the voltage applied to the piezoelectric oscillator 4) can be reduced by an amount of 20% or more.

### Third Embodiment

A third embodiment of the present invention is similar to the above-described first embodiment of the present invention except for a change indicated below.

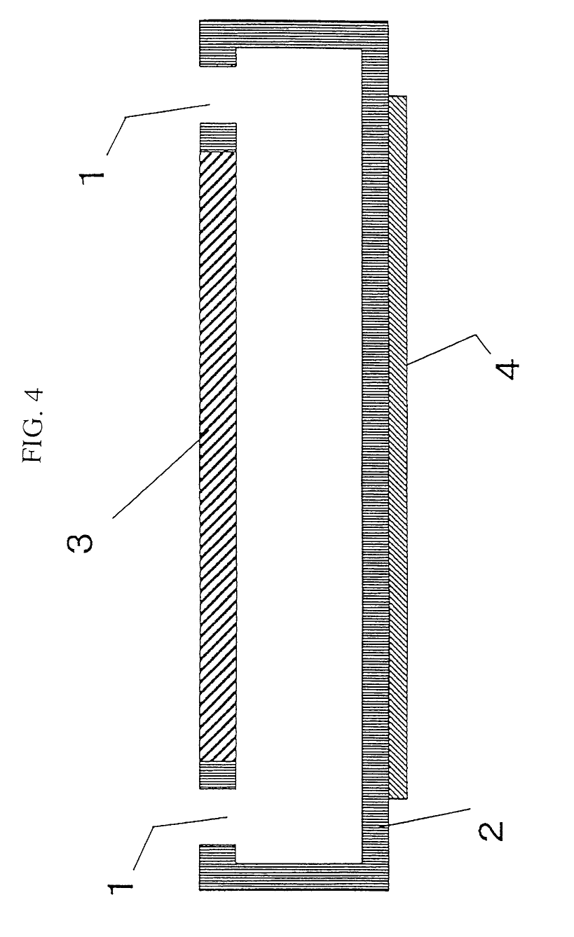

FIG. 4 shows an arrangement of the integrated information display and piezoelectric sound generating device in accordance with the third embodiment of the present invention.

The integrated information display and piezoelectric sound generating device shown in FIG. 4 is different from the device shown in FIG. 2 in that the piezoelectric oscillator 4 is provided on an outer bottom surface of the resonance box 2. The fundamental characteristics of this embodiment is substantially the same as those of the embodiment shown in FIG. 2.

### Fourth Embodiment

A fourth embodiment of the present invention is similar to the above-described first embodiment of the present invention except for a change indicated below.

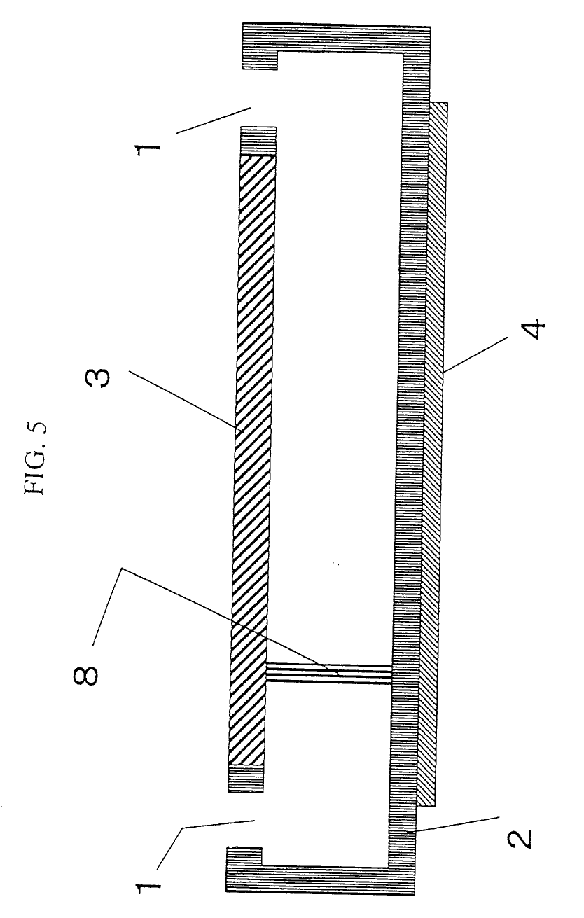

FIG. 5 shows an arrangement of the integrated information display and piezoelectric sound generating device in accordance with the fourth embodiment of the present invention.

The integrated information display and piezoelectric sound generating device shown in FIG. 5 is different from the device shown in FIG. 4 in that an oscillation transfer pole 8 is provided in the resonance box 2. The thin flat display 3 is rigidly connected to or mechanically linked with the piezoelectric oscillator 4 via the oscillation transfer pole 8. In other words, the oscillation transfer pole 8 directly transmits the vibration caused by the piezoelectric oscillator 4 to the thin flat display 3.

According to this arrangement, the oscillation of piezoelectric oscillator 4 is effectively transferred to the thin flat display 3 via the oscillation transfer pole 8. In this case, the oscillation transfer pole 8 is located at an appropriately position where the sound pressure can be maximized at a desired oscillation frequency band.

### Fifth Embodiment

A fifth embodiment of the present invention is similar to the above-described first embodiment of the present invention except for a change indicated below.

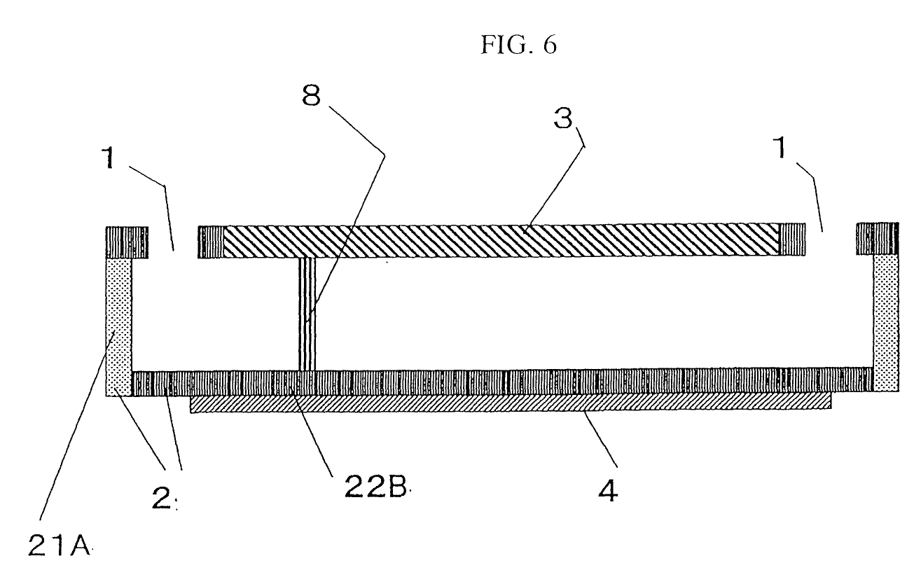

FIG. 6 shows an arrangement of the integrated information display and piezoelectric sound generating device in accordance with the fifth embodiment of the present invention.

The integrated information display and piezoelectric sound generating device shown in FIG. 6 is different from the device shown in FIG. 5 in that the resonance box 2 is made of a plurality of materials having different oscillatory or vibratory characteristics (such as elasticity). More specifically, the resonance box 2 is made of a first material 21A except for the bottom (i.e., the diaphragm) on which the piezoelectric oscillator 4 is provided. The bottom of resonance box 2 is made of a second material 21B. The elastic coefficient of second material 21B is larger than that of first material 21A. For example, the second material 21B is a polymeric material. The elastic coefficient of first material 21A is substantially identical with that of the thin flat display 3.

According to this embodiment, it becomes possible to adequately adjust the resonance frequency of resonance box 2 by selecting the combination of first material 21A and second material 21B. The sound components lower than 150 Hz can be effectively transmitted to the thin flat display 3 or output via the sound openings 1.

### Sixth Embodiment

A sixth embodiment of the present invention is similar to the above-described first embodiment of the present invention except for a change indicated below.

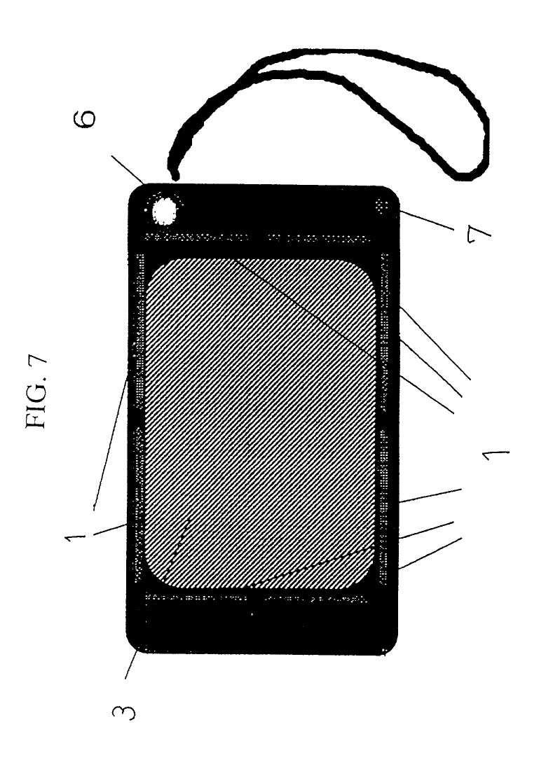

FIG. 7 shows a mobile information terminal incorporating the integrated information display and piezoelectric sound generating device in accordance with the preferred embodiment of the present invention.

According to the arrangement of the mobile information terminal of this invention, a core camera 6 and a microphone 7 are provided on a front face of the mobile information terminal, in addition to the thin flat display 3 and the sound openings 1 cooperatively constituting the integrated information display and piezoelectric sound generating device of this invention.

As understood from FIG. 7, integrally providing the sound openings 1 in the vicinity to or adjacent to a peripheral edge of thin flat display 3 is effective to save the space (especially, a space for a display screen) of the mobile information terminal and therefore it becomes possible to realize the downsizing of the mobile information terminal.

### Seventh Embodiment

A seventh embodiment of the present invention is similar to the above-described first embodiment of the present invention except for a change indicated below.

FIG. 8 shows a preferable wire arrangement of the integrated information display and piezoelectric sound generating device in accordance with the preferred embodiment of the present invention. FIG. 9 is a cross-sectional view of the integrated information display and piezoelectric sound generating device shown in FIG. 8.

Sound signal leads 11 and information display signal leads 12 extend out of the resonance box 2 via a hole (i.e., opening) provided on its bottom.

### Eighth Embodiment

An eighth embodiment of the present invention is similar to the above-described first embodiment of the present invention except for a change indicated below.

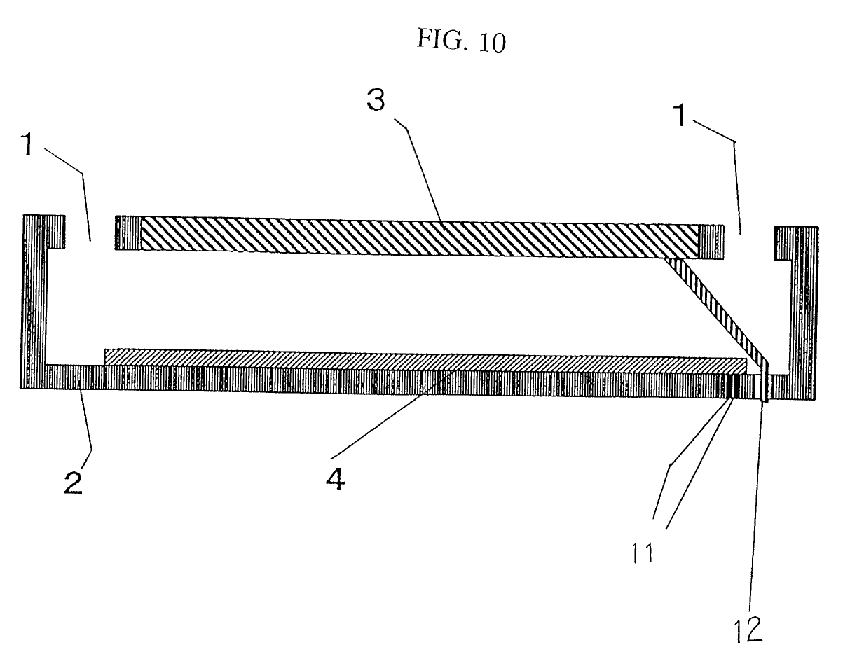

FIG. 10 is a cross-sectional view showing another arrangement of the integrated information display and piezoelectric sound generating device shown in FIG. 8. The resonance box 2 has electric terminals to which the signal leads of the piezoelectric oscillator 4 are connected by soldering or by means of connectors.

### Ninth Embodiment

A ninth embodiment of the present invention is similar to the above-described first embodiment of the present invention except for a change indicated below.

The ninth embodiment of the present invention relates to a portable telephone (e.g., a pocket telephone, a cellular telephone, a handy telephone, a wireless telephone, a PHS telephone).

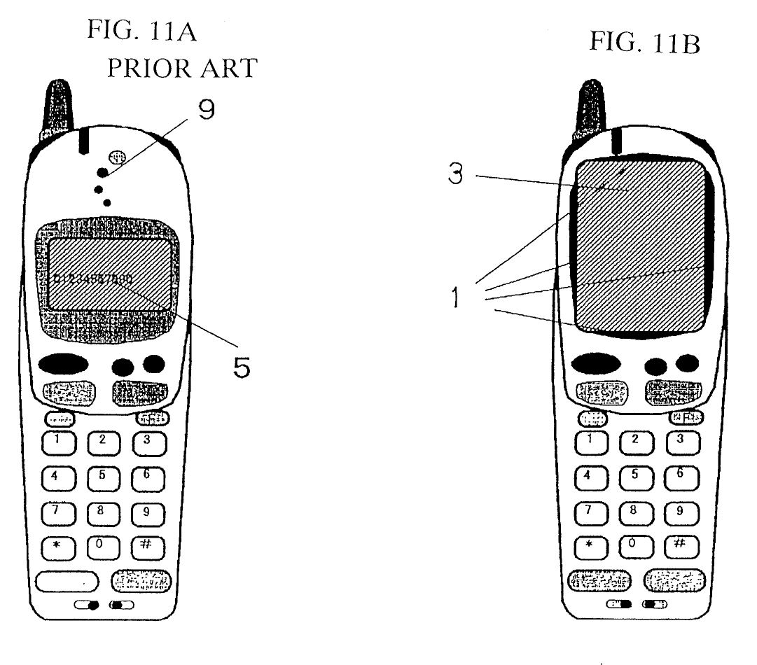

FIG. 11A shows a conventional portable telephone. According to the conventional portable telephone arrangement, a piezoelectric sound generating section 9 is separately provided from a display screen 5. An available area of display screen 5 is substantially restricted by the piezoelectric sound generating section 9.

FIG. 11B shows a portable telephone incorporating the integrated information display and piezoelectric sound generating device in accordance with the preferred embodiment of the present invention. According to this embodiment, the sound openings 1 are integrally provided in the vicinity of or adjacent to the peripheral region of the thin flat display 3. Thus, it becomes possible to enlarge the available area of the thin flat display 3.

### Tenth Embodiment

A tenth embodiment of the present invention is similar to the above-described first embodiment of the present invention except for a change indicated below.

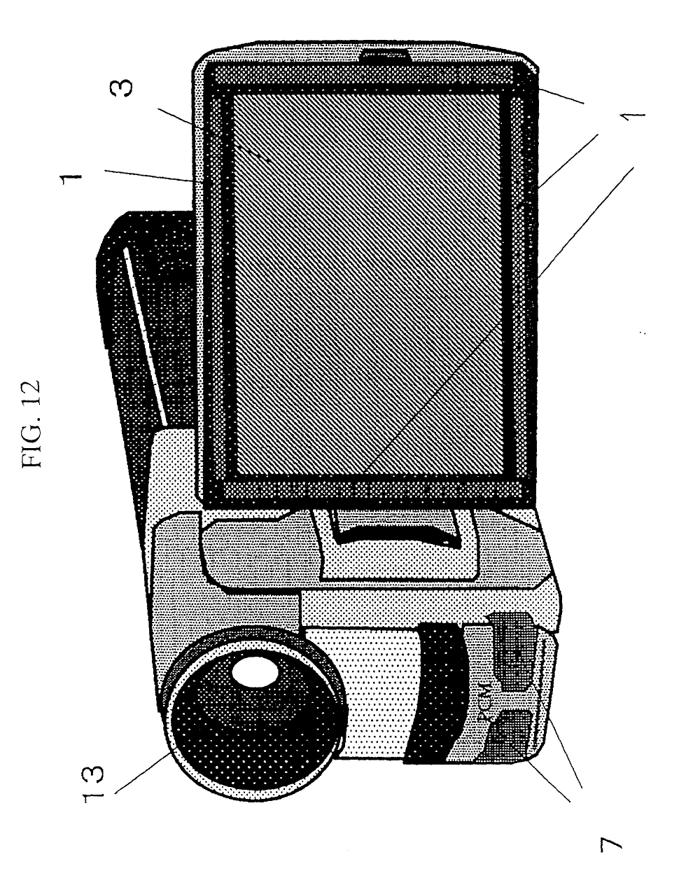

FIG. 12 shows a digital video camera in accordance with the tenth embodiment of the present invention. In this embodiment, the digital video camera is shown as one example of various recording and playback devices for recording and reproducing video and acoustic (or audio) information. The digital video camera shown in FIG. 12 incorporates the integrated information display and piezoelectric sound generating device in accordance with the preferred embodiment of the present invention. More specifically, a lens 13 and a microphone 7 are provided on a main body of the digital video camera. A thin flat display 3 and sound openings 1 are provided on a front face of a swingable lid of the digital video camera. The sound openings 1 are integrally provided in the vicinity of or adjacent to the peripheral region of the thin flat display 3 on the front face of this swingable lid. Thus, it becomes possible to enlarge the available area of the thin flat display 3.

### Other Embodiment

Furthermore, the integrated information display and piezoelectric sound generating device of this invention can be applied to a wristwatch type mobile information terminal or a DVD(i.e., digital versatile disk) player type mobile information terminal. In any case, the sound openings 1 are integrally provided in the vicinity of or adjacent to the thin flat display 3 on a front face of the device. Thus, it is possible to save the space of the devices and accordingly realize the downsizing for various types of information display devices.

What is claimed is:

1. An integrated information display and piezoelectric sound generating device comprising a thin-plate piezoelectric element serving as an oscillating source of a sound signal and a display device serving as part of a resonator.

2. The integrated information display and piezoelectric sound generating device in accordance with claim 1, wherein said thin-plate piezoelectric element is attached to a resonance box of said resonator.

3. The integrated information display and piezoelectric sound generating device in accordance with claim 2, wherein said display device is located on a top surface of said resonator.

4. The integrated information display and piezoelectric sound generating device in accordance with claim 1, wherein said thin-plate piezoelectric element is constituted by a plurality of piezoelectric oscillators.

5. The integrated information display and piezoelectric sound generating device in accordance with claim 1, wherein said thin-plate piezoelectric element is located in a lateral direction of said resonator and causes acoustic oscillation by repeating expansion and contraction in said lateral direction.

6. The integrated information display and piezoelectric sound generating device in accordance with claim 1, wherein said thin-plate piezoelectric element is connected to said thin flat display via an oscillation transfer pole.

7. The integrated information display and piezoelectric sound generating device in accordance with claim 1, wherein said display device is the one selected from the group consisting of a liquid crystal display, an organic electro-luminescent display, a reflection liquid crystal display, and a thin-film display formed on a resin substrate.

8. An integrated information display and piezoelectric sound generating device comprising:
a resonance box;
a piezoelectric oscillator attached to a surface of said resonance box; and
a thin flat display integrally formed with said resonance box.

9. The integrated information display and piezoelectric sound generating device in accordance with claim 8, wherein said thin flat display is integrally provided on a top surface of said resonance box.

10. The integrated information display and piezoelectric sound generating device in accordance with claim 9, wherein said piezoelectric oscillator is provided on an inner bottom surface of said resonance box.

11. The integrated information display and piezoelectric sound generating device in accordance with claim 9, wherein said piezoelectric oscillator is provided on an outer bottom surface of said resonance box.

12. The integrated information display and piezoelectric sound generating device in accordance with claim 9, wherein said piezoelectric oscillator is provided on each of inner and outer bottom surfaces of said resonance box.

13. The integrated information display and piezoelectric sound generating device in accordance with claim 8, wherein a plurality of sound openings are provided adjacent to said thin flat display on the top surface of said resonance box.

14. The integrated information display and piezoelectric sound generating device in accordance with claim 8, wherein said piezoelectric oscillator is connected to said thin flat display via an oscillation transfer pole.

15. The integrated information display and piezoelectric sound generating device in accordance with claim 8, wherein said piezoelectric oscillator has a thin-plate body extending parallel to said thin flat display.

16. The integrated information display and piezoelectric sound generating device in accordance with claim 8, wherein said thin flat display is a liquid crystal display.

17. The integrated information display and piezoelectric sound generating device in accordance with claim 8, wherein said thin flat display is an organic electro-luminescent display.

18. The integrated information display and piezoelectric sound generating device in accordance with claim 8, wherein said thin flat display is a reflection liquid crystal display.

19. The integrated information display and piezoelectric sound generating device in accordance with claim 8, wherein said thin flat display is a thin-film display formed on a resin substrate.

20. The integrated information display and piezoelectric sound generating device in accordance with claim 8, wherein said resonance box is made of a plurality of materials having different oscillatory characteristics.

21. The integrated information display and piezoelectric sound generating device in accordance with claim 20, wherein said resonance box is made of a first material except for the bottom on which said piezoelectric oscillator is provided, and the bottom of said resonance box is made of a second material.

22. The integrated information display and piezoelectric sound generating device in accordance with claim 21, wherein an elastic coefficient of said second material is larger than that of said first material.

23. The integrated information display and piezoelectric sound generating device in accordance with claim 22, wherein said second material is a polymeric material.

24. The integrated information display and piezoelectric sound generating device in accordance with claim 23, wherein an elastic coefficient of said first material is substantially identical with that of said thin flat display.

25. The integrated information display and piezoelectric sound generating device in accordance with claim 8, wherein said piezoelectric oscillator is connected to sound signal leads and said thin flat display is connected to display signal leads.

26. The integrated information display and piezoelectric sound generating device in accordance with claim 25, wherein said resonance box has a hole, and said sound signal leads and said information display signal leads extend out of said resonance box via said hole.

27. The integrated information display and piezoelectric sound generating device in accordance with claim 26, wherein said hole is provided on the bottom of said resonator box.

28. The integrated information display and piezoelectric sound generating device in accordance with claim 8, wherein said resonance box has electric terminals to which signal leads of said piezoelectric oscillator are connected by soldering or by means of connectors.

29. A mobile information terminal comprising:
a resonance box incorporated in a body of said mobile information terminal;
a piezoelectric oscillator provided on a bottom surface of said resonance box; and
a thin flat display formed on a top surface of said resonance box so that said thin flat display is located on a front face of said mobile information terminal.

30. The mobile information terminal in accordance with claim 29, wherein a plurality of sound openings are provided adjacent to said thin flat display on the front face of said mobile information terminal.

31. The mobile information terminal in accordance with claim 29, wherein a core camera and a microphone are provided on the front face of said mobile information terminal.

32. A wristwatch type mobile information terminal comprising:
a resonance box;
a piezoelectric oscillator provided on a bottom surface of said resonance box; and
a thin flat display formed on a top surface of said resonance box.

33. A digital versatile disk player comprising:
a resonance box;
a piezoelectric oscillator provided on a bottom surface of said resonance box; and
a thin flat display formed on a top surface of said resonance box.

34. A portable telephone comprising:
a resonance box incorporated in a body of said portable telephone;
a piezoelectric oscillator provided on a bottom surface of said resonance box;
a thin flat display formed on a top surface of said resonance box so that said thin flat display is located on a front face of said portable telephone; and
a plurality of sound openings provided in a peripheral region of said thin flat display located on the front face of said portable telephone.

35. A video camera comprising:
a resonance box incorporated in a body of said video camera;
a piezoelectric oscillator provided on a bottom surface of said resonance box;
a thin flat display formed on a top surface of said resonance box so that said thin flat display is located on a front face of said video camera; and
a plurality of sound openings provided in a peripheral region of said thin flat display located on the front face of said video camera.

36. The video camera in accordance with claim 35, wherein said resonance box is provided in a swingable lid of said video camera.

37. An apparatus for recording and reproducing video and acoustic information, said apparatus comprising:
a resonance box incorporated in a body of said recording and reproducing apparatus;
a piezoelectric oscillator provided on a bottom surface of said resonance box;
a thin flat display formed on a top surface of said resonance box so that said thin flat display is located on a front face of said recording and reproducing apparatus; and
a plurality of sound openings provided in a peripheral region of said thin flat display located on the front face of said recording and reproducing apparatus.
